(19) United States
(12) Patent Application Publication
(10) Pub. No.: US 2023/0017964 A1
(43) Pub. Date: Jan. 19, 2023

(54) BALANCED SWITCHABLE CONFIGURATION FOR A PANCHARATNAM-BERRY PHASE (PBP) LENS

(71) Applicant: Meta Platforms Technologies, LLC, Menlo Park, CA (US)

(72) Inventors: Hannah Noble, Sunnyvale, CA (US); Yang Zhao, Kirkland, WA (US); Chia-Hsuan Tai, San Jose, CA (US)

(73) Assignee: Meta Platforms Technologies, LLC, Menlo Park, CA (US)

(21) Appl. No.: 17/379,625

(22) Filed: Jul. 19, 2021

(51) Int. Cl. G02F 1/01

(52) U.S. Cl. CPC G02F 1/0136; G02B 27/0172

(57) ABSTRACT

An optical lens assembly to accept various illumination ellipticity profiles as angle of incidence (AOI) varies is provided. The optical lens assembly may include an optical stack, such as pancake optics. The optical lens assembly may also include a switchable optical element communicatively coupled to a controller. The optical lens assembly may further include an optical element, such as a Pancharatnam-Berry phase (PBP) lens, also known as a geometric phase lens (GPL). In some examples, the switchable optical element may be a switchable have wave plate, which may be configured, via application of optical power by the controller, so that the optical lens assembly may accept varying illumination ellipticity profiles as angle of incidence (AOI) increases.

### TECHNICAL FIELD

This patent application relates generally to optical lens design and configurations in optical systems, such as head-mounted displays (HMDs), and more specifically, to systems and methods for providing balanced switchable configurations for a Pancharatnam-berry phase (PBP) lens, also known as geometric phase lens (GPL) or diffractive waveplate, to accept various illumination ellipticity profiles as angle of incidence (AOI) varies.

### BACKGROUND

Optical lens design and configurations are part of many modern-day devices, such as cameras used in mobile phones and various optical devices. One such optical device that relies on optical lens design is a head-mounted display (HMD). In some examples, a head-mounted display (HMD) may be a headset or eyewear used for video playback, gaming, or sports, and in a variety of contexts and applications, such as virtual reality (VR), augmented reality (AR), or mixed reality (MR).

Some head-mounted displays (HMDs) rely on certain optical elements. For instance, a Pancharatnam-Berry phase (PBP) lens, also known as a geometric phase lens (GPL), may be an optical element used in certain switchable accommodation applications. The Pancharatnam-Berry phase (PBP) lens, however, is typically designed for circularly polarized illumination, at normal or non-normal angles of incidence (AOI). If illumination is elliptical or not strictly or perfectly circularly polarized, the Pancharatnam-Berry phase (PBP) lens may generate adverse “ghost” effects. These effects may consist of undesirable diffraction order transmission and distort vision for a user or wearer of the head-mounted display (HMD).

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of a system associated with a head-mounted display (HMD), according to an example.

FIGS. 2A-2B illustrate various head-mounted displays (HMDs), in accordance with an example.

FIGS. 3A-3D illustrates schematic diagrams of a Pancharatnam-Berry phase (PBP) lens, according to an example.

FIG. 4 illustrates an optical configuration for a switchable accommodation using a Pancharatnam-berry phase (PBP) lens and switchable half wave plate, according to an example.

FIG. 5 illustrates a geometric ray trace for an optical configuration, according to an example.

FIGS. 6A-6F illustrate graphs balances and imbalanced switchable half wave plate configurations, according to an example.

FIGS. 7A-7B illustrate Pancharatnam-berry phase (PBP) illumination design conditions, according to an example.

FIG. 8 illustrates a flow chart of a method for providing balanced switchable configurations for a Pancharatnam-berry phase (PBP) lens to accept various illumination ellipticity profiles as angle of incidence (AOI) varies, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

There are many types of optical devices that utilize optical design configurations. For example, a head-mounted display (HMD) is an optical device that may communicate information to or from a user who is wearing the headset. For example, a virtual reality (VR) headset may be used to present visual information to simulate any number of virtual environments when worn by a user. That same virtual reality (VR) headset may also receive information from the user's eye movements, head/body shifts, voice, or other user-provided signals.

In many cases, optical lens design configurations seek to decrease headset size, weight, and overall bulkiness. However, these attempts to provide a small form factor often limits the function of the head-mounted display (HMD). For example, while attempts to reduce the size and bulkiness of various optical configurations in conventional headsets can be achieved, this often reduces the amount of space needed for other built-in features of a headset, thereby restricting or limiting a headset's ability to function at full capacity. A conventional head-mounted display (HMD) may also encounter other various issues, such as “ghosts,” which may be prevalent various optical lens design configurations, especially in switchable accommodations involving use of a Pancharatnam-Berry phase (PBP), also known as a geometric phase lens (GPL).

As mentioned above, the Pancharatnam-Berry phase (PBP) lens, in some examples, may be specifically designed for circularly polarized illumination, at normal and/or non-normal angles of incidence (AOI). If illumination is not strictly or perfectly circularly polarized (i.e., elliptically polarized), the Pancharatnam-Berry phase (PBP) lens may create undesirable visual artifacts, often referred to as “ghosts,” which can introduce duplicate images (“double-imaging”), reduce clarity, and other visual artifacts for a user or wearer of the head-mounted display (HMD).

For a switchable accommodation to function with a Pancharatnam-Berry phase (PBP) lens, an optical element, such as a switchable half wave retarder, may be used to “flip” illumination from right circular polarized (RCP) to left circular polarized (LCP) illumination. However, there are many notable challenges with optimizing the various states of a half wave retarder in these switchable applications.

The systems and methods described herein may provide at least one configuration for a “balanced” switchable half wave plate (or other similar switchable optical element), which, for example, may be used in a head-mounted display (HMD) or other optical applications. It should be appreciated that the design of the switchable optical element or half wave plate may include a liquid crystal (LC) cell design, which may be optimized so that the “on” state elliptically, as a function of angle of incidence (AOI) and azimuth, is closely matched to the “off” state elliptically, as a function of angle of incidence (AOI) and azimuth. It should be appreciated that “azimuth” angle, as used herein, may be used interchangeably with “polar” angle. In this way, the Pancharatnam-Berry phase (PBP) lens may be designed or optimized to accept varying illumination ellipticity profiles, in order to compensate for situations where the ellipticity degrades as angle of incidence (AOI) increases. In this way, adverse optical effects, such as “ghosts” may be reduced or eliminated. These and other examples will be described in more detail herein.

It should also be appreciated that the systems and methods described herein may be particularly suited for virtual reality (VR), augmented reality (AR), and/or mixed reality (MR) environments, but may also be applicable to a host of other systems or environments that include optical configurations using a Pancharatnam-Berry phase (PBP) lens, geometric phase lens (GPL), and/or a switchable half wave plate/retarder. These may include, for example, cameras or sensors, networking, telecommunications, holography, or other optical systems. Thus, the optical configurations described herein, may be used in any of these or other examples. These and other benefits will be apparent in the description provided herein.

### System Overview

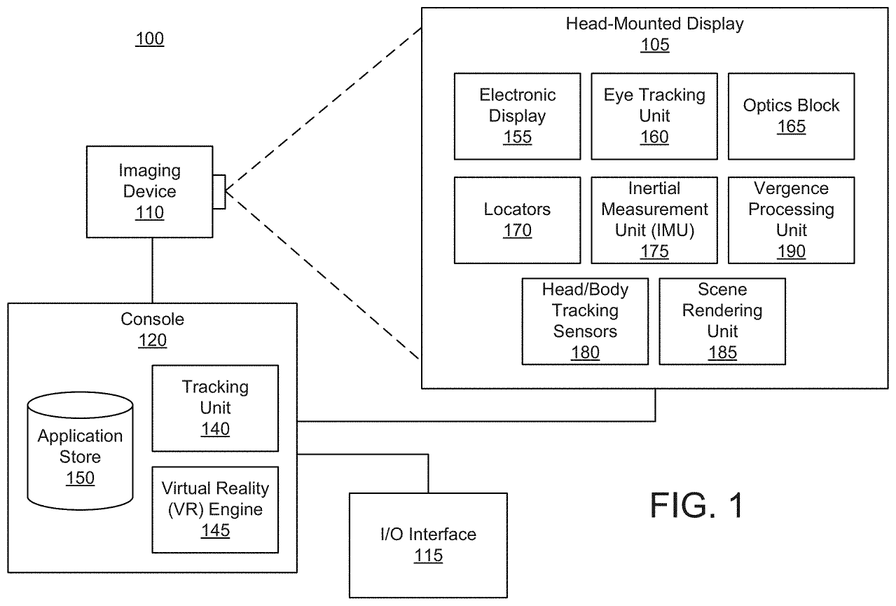

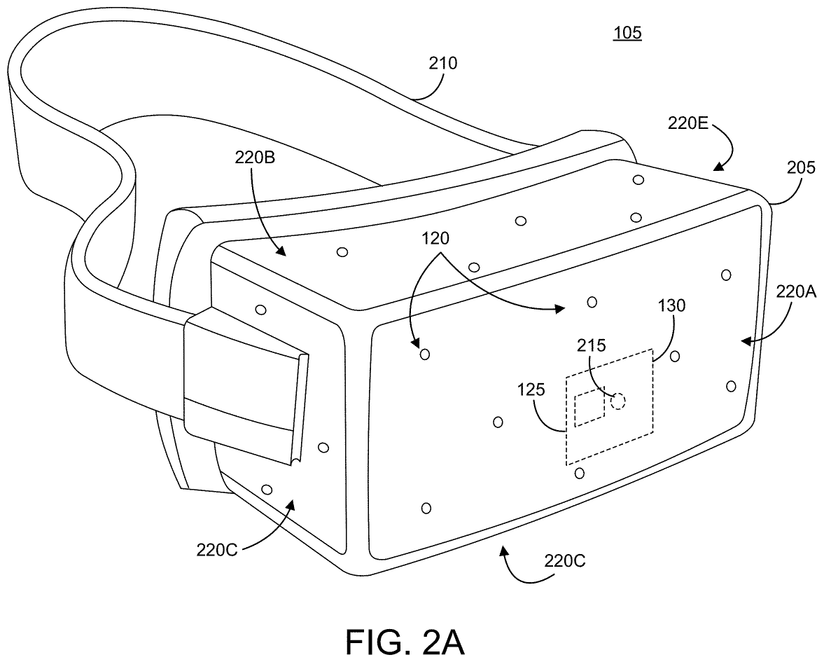

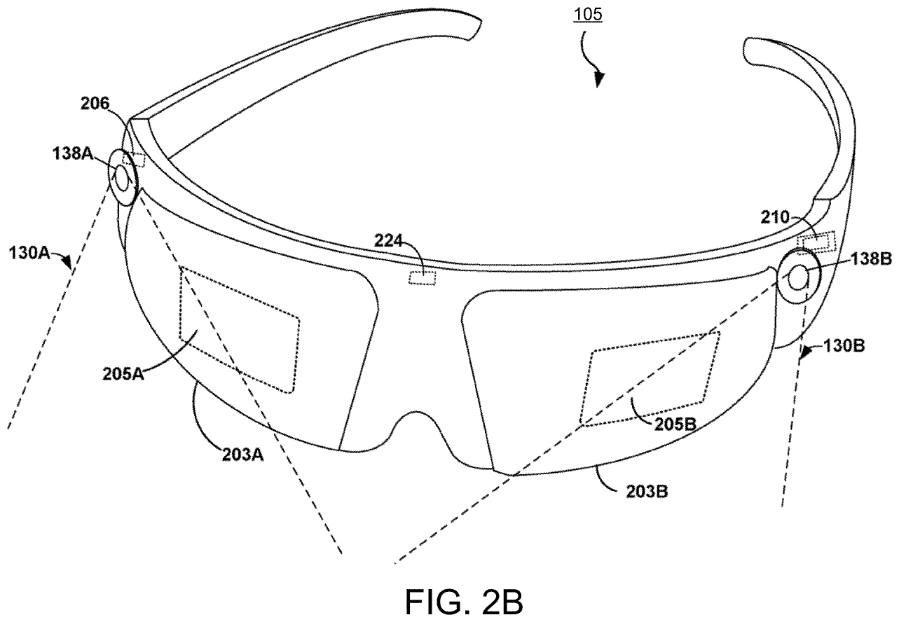

Reference is made to FIGS. 1 and 2A-2B. FIG. 1 illustrates a block diagram of a system 100 associated with a head-mounted display (HMD), according to an example. The system 100 may be used as a virtual reality (VR) system, an augmented reality (AR) system, a mixed reality (MR) system, or some combination thereof, or some other related system. It should be appreciated that the system 100 and the head-mounted display (HMD) 105 may be exemplary illustrations. Thus, the system 100 and/or the head-mounted display (HMD) 105 may or not include additional features and some of the features described herein may be removed and/or modified without departing from the scopes of the system 100 and/or the head-mounted display (HMD) 105 outlined herein.

In some examples, the system 100 may include the head-mounted display (HMD) 105, an imaging device 110, and an input/output (I/O) interface 115, each of which may be communicatively coupled to a console 120 or other similar device.

While FIG. 1 shows a single head-mounted display (HMD) 105, a single imaging device 110, and an I/O interface 115, it should be appreciated that any number of these components may be included in the system 100. For example, there may be multiple head-mounted displays (HMDs) 105, each having an associated input/output (I/O) interface 115 and being monitored by one or more imaging devices 110, with each head-mounted display (HMD) 105, I/O interface 115, and imaging devices 110 communicating with the console 120. In alternative configurations, different and/or additional components may also be included in the system 100. As described herein, the head-mounted display (HMD) 105 may act be used as a virtual reality (VR), augmented reality (AR), and/or a mixed reality (MR) head-mounted display (HMD). A mixed reality (MR) and/or augmented reality (AR) head-mounted display (HMD), for instance, may augment views of a physical, real-world environment with computer-generated elements (e.g., images, video, sound, etc.).

The head-mounted display (HMD) 105 may communicate information to or from a user who is wearing the headset. In some examples, the head-mounted display (HMD) 105 may provide content to a user, which may include, but not limited to, images, video, audio, or some combination thereof. In some examples, audio content may be presented via a separate device (e.g., speakers and/or headphones) external to the head-mounted display (HMD) 105 that receives audio information from the head-mounted display (HMD) 105, the console 120, or both. In some examples, the head-mounted display (HMD) 105 may also receive information from a user. This information may include eye moments, head/body movements, voice (e.g., using an integrated or separate microphone device), or other user-provided content.

The head-mounted display (HMD) 105 may include any number of components, such as an electronic display 155, an eye tracking unit 160, an optics block 165, one or more locators 170, an inertial measurement unit (IMU) 175, one or head/body tracking sensors 180, and a scene rendering unit 185, and a vergence processing unit 190.

While the head-mounted display (HMD) 105 described in FIG. 1 is generally within a VR context as part of a VR system environment, the head-mounted display (HMD) 105 may also be part of other HMD systems such as, for example, an AR system environment. In examples that describe an AR system or MR system environment, the head-mounted display (HMD) 105 may augment views of a physical, real-world environment with computer-generated elements (e.g., images, video, sound, etc.).

An example of the head-mounted display (HMD) 105 is further described below in conjunction with FIG. 2. The head-mounted display (HMD) 105 may include one or more rigid bodies, which may be rigidly or non-rigidly coupled to each other together. A rigid coupling between rigid bodies causes the coupled rigid bodies to act as a single rigid entity. In contrast, a non-rigid coupling between rigid bodies allows the rigid bodies to move relative to each other.

The electronic display 155 may include a display device that presents visual data to a user. This visual data may be transmitted, for example, from the console 120. In some examples, electronic display 155 may also present tracking light for tracking the users eye movements. It should be appreciated that the electronic display 155 may include any number of electronic; display elements (e.g., a display for each of the user). Examples of a display device that may be used in the electronic display 155 may include, but not limited to a liquid crystal display (LCD), a light emitting diode (LED), an organic light emitting diode (OLED) display, an active-matrix organic light-emitting diode (AMOLED) display, micro light emitting diode (micro-LED) display, some other display, or some combination thereof.

The optics block 165 may adjust its focal length based on or in response to instructions received from the console 120 or other component. In some examples, the optics block 165 may include a multi multifocal block to adjust a focal length (adjusts optical power) of the optics block 165.

The eye tracking unit 160 may track an eye position and eye movement of a user of the head-mounted display (HMD) 105. A camera or other optical sensor inside the head-mounted display (HMD) 105 may capture image information of a user's eyes, and the eye tracking unit 160 may use the captured information to determine interpupillary distance, interocular distance, a three-dimensional (3D) position of each eye relative to the head-mounted display (HMD) 105 (e.g., for distortion adjustment purposes), including a magnitude of torsion and rotation (i.e., roll, pitch, and yaw) and gaze directions for each eye. The information for the position and orientation of the user's eyes may be used to determine the gaze point in a virtual scene presented by the head-mounted display (HMD) 105 where the user is looking.

The vergence processing unit 190 may determine a vergence depth of a user's gaze. In some examples, this may be based on the gaze point or an estimated intersection of the gaze lines determined by the eye tracking unit 160. Vergence is the simultaneous movement or rotation of both eyes in opposite directions to maintain single binocular vision, which is naturally and/or automatically performed by the human eye. Thus, a location where a user's eyes are verged may refer to where the user is looking and may also typically be the location where the user's eyes are focused. For example, the vergence processing unit 190 may triangulate the gaze lines to estimate a distance or depth from the user associated with intersection of the gaze lines. The depth associated with intersection of the gaze lines can then be used as an approximation for the accommodation distance, which identifies a distance from the user where the user's eyes are directed. Thus, the vergence distance allows determination of a location where the user's eyes should be focused.

The one or more locators 170 may be one or more objects located In specific positions on the head-mounted display (HMD) 105 relative to one another and relative to a specific reference point on the head-mounted display (HMD) 105. A locator 170, in some examples, may be a light emitting diode (LED), a corner cube reflector, a reflective marker, and/or a type of light source that contrasts with an environment in which the head-mounted display (HMD) 105 operates, or some combination thereof. Active locators 170 (e.g., an LED or other type of light emitting device) may emit light in the visible band (“380 nm to 850 nm), in the infrared (IR) band (“850 nm to 1 mm), in the ultraviolet band (10 nm to 380 nm), some other portion of the electromagnetic spectrum, or some combination thereof.

The one or more locators 170 may be located beneath an outer surface of the head-mounted display (HMD) 105, which may be transparent to wavelengths of light emitted or reflected by the locators 170 or may be thin enough not to substantially attenuate wavelengths of light emitted or reflected by the locators 170. Further, the outer surface or other portions of the head-mounted display (HMD) 105 may be opaque in the visible band of wavelengths of light. Thus, the one or more locators 170 may emit light in the IR band while under an outer surface of the head-mounted display (HMD) 105 that may be transparent in the IR band but opaque in the visible band.

The inertial measurement unit (IMU) 175 may be an electronic device that generates, among other things, fast calibration data based on or in response to measurement signals received from one or more of the head/body tracking sensors 180, which may generate one or more measurement signals in response to motion of head-mounted display (HMD) 105. Examples of the head/body tracking sensors 180 may include, but not limited to, accelerometers, gyroscopes, magnetometers, cameras, other sensors suitable for detecting motion, correcting error associated with the inertial measurement unit (IMU) 175, or some combination thereof. The head/body tracking sensors 180 may be located external to the inertial measurement unit (IMU) 175, internal to the inertial measurement unit (IMU) 175, or some combination thereof.

Based on or in response to the measurement signals from the head/body tracking sensors 180, the inertial measurement unit (IMU) 175 may generate fast calibration data indicating an estimated position of the head-mounted display (HMD) 105 relative to an initial position of the head-mounted display (HMD) 105. For example, the head/body tracking sensors 180 may include multiple accelerometers to measure translational motion (forward/back, up/down, left/right) and multiple gyroscopes to measure rotational motion (e.g., pitch, yaw, and roll). The inertial measurement unit (IMU) 175 may then, for example, rapidly sample the measurement signals and/or calculate the estimated position of the head-mounted display (HMD) 105 from the sampled data. For example, the inertial measurement unit (IMU) 175 may integrate measurement signals received from the accelerometers over time to estimate a velocity vector and integrates the velocity vector over time to determine an estimated position of a reference point on the head-mounted display (HMD) 105. It should be appreciated that the reference point may be a point that may be used to describe the position of the head-mounted display (HMD) 105. While the reference point may generally be defined as a point in space, in various examples or scenarios, a reference point as used herein may be defined as a point within the head-mounted display (HMD) 105 (e.g., a center of the inertial measurement unit (IMU) 175). Alternatively or additionally, the inertial measurement unit (IMU) 175 may provide the sampled measurement signals to the console 120, which may, determine the fast calibration data or other similar or related data.

The inertial measurement unit (IMU) 175 may, additionally receive one or more calibration parameters from the console 120. As described herein, the one or more calibration parameters may be used to maintain tracking of the head-mounted display (HMD) 105. Based on a received calibration parameter, the inertial measurement unit (IMU) 175 may adjust one or more of the IMU parameters (e.g., sample rate). In some examples, certain calibration parameters may cause the inertial measurement unit (IMU) 175 to update an initial position of the reference point to correspond to a next calibrated position of the reference point. Updating the initial position of the reference point as the next calibrated position of the reference point may help reduce accumulated error associated with determining the estimated position. The accumulated error, also referred to as drift error, may cause the estimated position of the reference point to “drift” away from the actual position of the reference point over time.

The scene rendering unit 185 may receive content for the virtual scene from a VR engine 145 and may provide the content for display on the electronic display 155. Additionally or alternatively, the scene rendering unit 185 may adjust the content based on information from the inertial measurement unit (IMU) 175, the vergence processing unit 190, and/or the head/body tracking sensors 180. The scene rendering unit 185 may determine a portion of the content to be displayed on the electronic display 155 based at least in part on one or more of the tracking unit 140, the head/body tracking sensors 180, and/or the inertial measurement unit (IMU) 175.

The imaging device 110 may, generate slow calibration data in accordance with calibration parameters received from the console 120, Slow calibration data may include one or more images showing observed positions of the locators 125 that are detectable by imaging device 110. The imaging device 110 may include one or more cameras, one or more video cameras, other devices capable of capturing images including one or more locators 170, or some combination thereof. Additionally, the imaging device 110 may include one or more filters (e.g., for increasing signal to noise ratio). The imaging device 110 may be configured to detect light emitted or reflected from the one or more locators 170 in a field of view of the imaging device 110. In examples where the locators 170 include one or more passive elements (e.g., a retroreflector), the imaging device 110 may include a light source that illuminates some or all of the locators 170, which may retro-reflect the light towards the light source in the imaging device 110. Slow calibration data may be communicated from the imaging device 110 to the console 120, and the imaging device 110 may receive one or more calibration parameters from the console 120 to adjust one or more imaging parameters (e.g., focal length, focus, frame rate, ISO, sensor temperature, shutter speed, aperture, etc.).

The I/O interface 115 may be a device that allows a user to send action requests to the console 120. An action request may be a request to perform a particular action. For example, an action request may be to start or end an application or to perform a particular action within the application. The I/O interface 115 may include one or more input devices. Example input devices may include a keyboard, a mouse, a hand-held controller, a glove controller, and/or any other suitable device for receiving action requests and communicating the received action requests to the console 120. An action request received by the I/O interface 115 may be communicated to the console 120, which may perform an action corresponding to the action request. In some examples, the I/O interface 115 may provide haptic feedback to the user in accordance with instructions received from the console 120. For example, haptic feedback may be provided by the I/O interface 115 when an action request is received, or the console 120 may communicate instructions to the I/O interface 115 causing the I/O interface 115 to generate haptic feedback when the console 120 performs an action.

The console 120 may provide content to the head-mounted display (HMD) 105 for presentation to the user in accordance with information received from the imaging device 110, the head-mounted display (HMD) 105, or the I/O interface 115. The console 120 includes an application store 150, a tracking unit 140, and the VR engine 145. Some examples of the console 120 have different or additional units then those described in conjunction with FIG. 1. Similarly, the functions further described below may be distributed among components of the console 120 in a different manner than is described here.

The application store 150 may store one or more applications for execution by the console 120, as well as other various application-related data. An application, as used herein, may refer to a group of instructions, that when executed by a processor, generates content for presentation to the user. Content generated by an application may be in response to inputs received from the user via movement of the head-mounted display (HMD) 105 or the I/O interface 115. Examples of applications may include gaming applications, conferencing applications, video playback application, or other applications.

The tracking unit 140 may calibrate the system 100. This calibration may be achieved by using one or more calibration parameters and may adjust one or more calibration parameters to reduce error in determining position of the head-mounted display (HMD) 105. For example, the tracking unit 140 may adjust focus of the imaging device 110 to obtain a more accurate position for observed locators 170 on the head-mounted display (HMD) 105. Moreover, calibration performed by the tracking unit 140 may also account for information received from the inertial measurement unit (IMU) 175. Additionally, if tracking of the head-mounted display (HMD) 105 is lost (e.g., imaging device 110 loses line of sight of at least a threshold number of locators 170), the tracking unit 140 may re-calibrate some or all of the system 100 components.

Additionally, the tracking unit 140 may track the movement of the head-mounted display (HMD) 105 using slow calibration information from the imaging device 110 and may determine positions of a reference point on the head-mounted display (HMD) 105 using observed locators from the slow calibration information and a model of the head-mounted display (HMD) 105. The tracking unit 140 may also determine positions of the reference point on the head-mounted display (HMD) 105 using position information from the fast calibration information from the inertial measurement unit (NU) 175 on the head-mounted display (HMD) 105, Additionally, the eye tracking unit 160 may use portions of the fast calibration information, the slow calibration information, or some combination thereof, to predict a future location of the head-mounted display (HMD) 105, which may be provided to the VR engine 145.

The VR engine 145 may execute applications within the system 100 and may receive position information, acceleration information, velocity information, predicted future positions, other information, or some combination thereof for the head-mounted display (HMD) 105 from the tracking unit 140 or other component. Based on or in response to the received information, the VR engine 145 may determine content to provide to the head-mounted display (HMD) 105 for presentation to the user. This content may include, but not limited to, a virtual scene, one or more virtual objects to overlay onto a real world scene, etc.

In some examples, the VR engine 145 may maintain focal capability information of the optics block 165. Focal capability information, as used herein, may refer to information that describes what focal distances are available to the optics block 165. Focal capability information may include, e.g., a range of focus the optics block 165 is able to accommodate (e.g., 0 to 4 diopters), a resolution of focus (e.g., 0.25 diopters), a number of focal planes, combinations of settings for switchable half wave plates (SHWPs) (e.g., active or non-active) that map to particular focal planes, combinations of settings for SHWPs and active liquid crystal lenses that map to particular focal planes, or some combination thereof.

The VR engine 145 may generate instructions for the optics block 165. These instructions may cause the optics block 165 to adjust its focal distance to a particular location. The VR engine 145 may generate the instructions based on focal capability information and, e.g., information from the vergence processing unit 190, the inertial measurement unit (IMU) 175, and/or the head/body tracking sensors 180. The VR engine 145 may use information from the vergence processing unit 190, the inertial measurement unit (IMU) 175, and the head/body tracking sensors 180, other source, or some combination thereof, to select an ideal focal plane to present content to the user. The VR engine 145 may then use the focal capability information to select a focal plane that is closest to the ideal focal plane. The VR engine 145 may use the focal information to determine settings for one or more SHWPs, one or more active liquid crystal lenses, or some combination thereof, within the optics block 176 that are associated with the selected focal plane. The VR engine 145 may generate instructions based on the determined settings, and may provide the instructions to the optics block 165.

The VP engine 145 may perform any number of actions within an application executing on the console 120 in response to an action request received from the I/O interface 115 and may provide feedback to the user that the action was performed. The provided feedback may be visual or audible feedback via the head-mounted display (HMD) 105 or haptic feedback via the I/O interface 115. Although the VP engine 145 is generally directed to virtual reality (VR) applications, a should be appreciated that the VP engine 145 may be used in any number of applications, such as augmented reality (AR), mixed reality (MR), or other scenarios beyond virtual reality (VR).

FIGS. 2A-2B illustrate various head-mounted displays (HMDs), in accordance with an example. FIG. 2A shows a head-mounted display (HMD) 105, in accordance with an example. The head-mounted display (HMD) 105 may include a front rigid body 205 and a band 210. The front rigid body 205 may include an electronic display (not shown), an inertial measurement unit (IMU) 175, one or more position sensors (e.g., head/body tracking sensors 180), and one or more locators 170, as described herein. In some examples, a user movement may be detected by use of the inertial measurement unit (IMU) 175, position sensors (e.g., head/body tracking sensors 180), and/or the one or more locators 170, and an image may be presented to a user through the electronic display based on or in response to detected user movement. In some examples, the head-mounted display (HMD) 105 may be used for presenting a virtual reality, an augmented reality, or a mixed reality environment.

At least one position sensor, such as the head/body tracking sensor 180 described with respect to FIG. 1, may generate one or more measurement signals in response to motion of the head-mounted display (HMD) 105. Examples of position sensors may includer one or more accelerometers, one or more gyroscopes, one or more magnetometers, another suitable type of sensor that detects motion, a type of sensor used for error correction of the inertial measurement unit (MU) 175, or some combination thereof. The position sensors may be located external to the inertial measurement unit (IMU) 175, internal to the inertial measurement unit (IMU) 175, or some combination thereof. In FIG. 2A, the position sensors may be located within the inertial measurement unit (IMU) 175, and neither the inertial measurement unit (IMU) 175 nor the position sensors (e.g., head/body tracking sensors 180) may or may not necessarily be visible to the user.

Based on the one or more measurement signals from one or more position sensors, the inertial measurement unit (IMU) 175 may generate calibration data indicating an estimated position of the head-mounted display (HMD) 105 relative to an initial position of the head-mounted display (HMD) 105. In some examples, the inertial measurement unit (IMU) 175 may rapidly sample the measurement signals and calculates the estimated position of the head-mounted display (HMD) 105 from the sampled data. For example, the inertial measurement unit (IMU) 175 may integrate the measurement signals received from the one or more accelerometers (or other position sensors) over time to estimate a velocity vector and integrates the velocity vector over time to determine an estimated position of a reference point on the head-mounted display (HMD) 105, Alternatively or additionally, the inertial measurement unit (IMU) 175 may provide the sampled measurement signals to a console (e.g.; a computer), which may determine the calibration data. The reference point may be a point that may be used to describe the position of the head-mounted display (HMD) 105. While the reference point may generally be defined as a point in space; however, in practice, the reference point may be defined as a point within the head-mounted display (HMD) 105 (e.g., a center of the inertial measurement unit (IMU) 175).

One or more locators 170, or portions of locators 170, may be located on a front side 240A, a top side 240B, a bottom side 240C, a right side 240D, and a left side 240E of the front rigid body 205 in the example of FIG. 2. The one or more locators 170 may be located in fixed positions relative to one another and relative to a reference point 215. In FIG. 2, the reference point 215, for example, may be located at the center of the inertial measurement unit (IMU) 175. Each of the one or more locators 170 may emit light that is detectable by an imaging device (e.g., camera or an image sensor).

FIG. 2B illustrates a head-mounted displays (HMDs), in accordance with another example. As shown in FIG. 2B, the head-mounted display (HMD) 105 may take the form of a wearable, such as glasses. The head-mounted display (HMD) 105 of FIG. 2A may be another example of the head-mounted display (HMD) 105 of FIG. 1. The head-mounted display (HMD) 105 may be part of an artificial reality (AR) system, or may operate as a stand-alone, mobile artificial realty system configured to implement the techniques described herein.

In some examples, the head-mounted display (HMD) 105 may be glasses comprising a front frame including a bridge to allow the head-mounted display (HMD) 105 to rest on a user's nose and temples (or “arms”) that extend over the user's ears to secure the head-mounted display (HMD) 105 to the user. In addition, the head-mounted display (HMD) 105 of FIG. 2B may include one or more interior-facing electronic displays 203A and 203B (collectively, “electronic displays 203”) configured to present artificial reality content to a user and one or more varifocal optical systems 205A and 205B (collectively, “varifocal optical systems 205”) configured to manage light output by a display 203, e.g., an interior-facing electronic display. In some examples, a known orientation and position of display 203 relative to the front frame of the head-mounted display (HMD) 105 may be used as a frame of reference, also referred to as a local origin, when tracking the position and orientation of the head-mounted display (HMD) 105 for rendering artificial reality (AR) content, for example, according to a current viewing perspective of the head-mounted display (HMD) 105 and the user.

As further shown in FIG. 2B, the head-mounted display (HMD) 105 may further include one or more motion sensors 206, one or more integrated image capture devices 138A and 138B (collectively, “image capture devices 138”), an internal control unit 210, which may include an internal power source and one or more printed-circuit boards having one or more processors, memory, and hardware to provide an operating environment for executing programmable operations to process sensed data and present artificial reality content on display 203. These components may be local or remote, or a combination thereof.

Although depicted as separate components in FIG. 1 it should be appreciated that the head-mounted display (HMD) 105, the imaging device 110, the I/O interface 115, and the console 120 may be integrated into a single device or wearable headset. For example, this single device or wearable headset (e.g., the head-mounted display (HMD) 105 of FIGS. 2A-2B) may include all the performance capabilities of the system 100 of FIG. 1 within a single, self-contained headset. Also, in some examples, tracking may be achieved using an “inside-out” approach, rather than an “outside-in” approach. In an “inside-out” approach, an external imaging device 110 or locators 170 may not be needed or provided to system 100. Moreover, although the head-mounted display (HMD) 105 is depicted and described as a “headset,” it should be appreciated that the head-mounted display (HMD) 105 may also be provided as eyewear or other wearable device (on a head or other body part), as shown in FIG. 2A. Other various examples may also be provided depending on use or application.

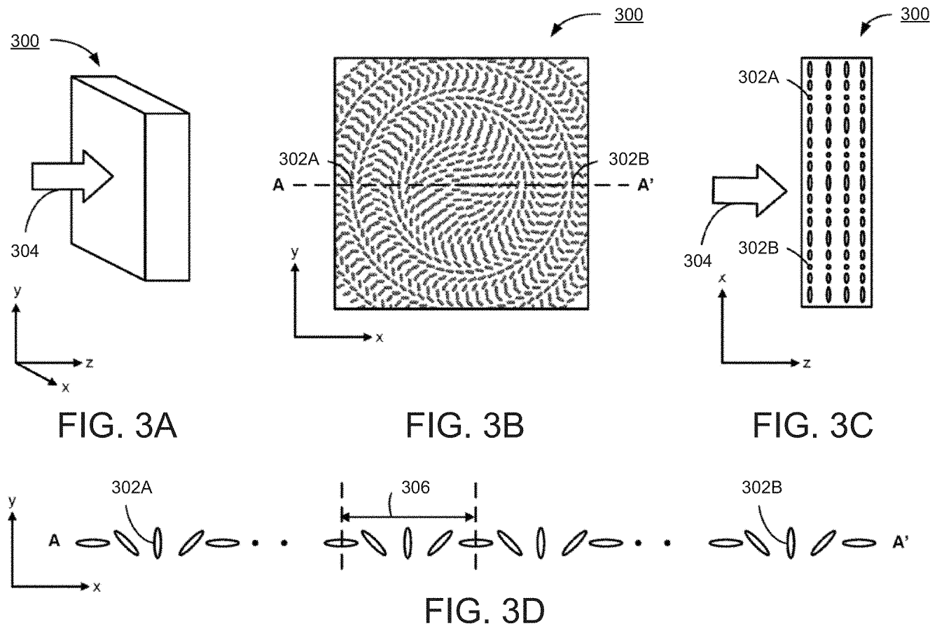

FIGS. 3A-3D illustrates schematic diagrams of a Pancharatnam-Berry phase (PBP) lens, according to an example. FIGS. 3A-3D are schematic diagrams illustrating a Pancharatnam-Berry phase (PBP) lens 300 configured to exhibit spherical lensing in accordance with some examples. In some examples, second optical element 814 of an optical stage in a varifocal optical assembly, includes a Pancharatnam-Berry phase (PBP) lens 300. In some examples, the Pancharatnam-Berry phase (PBP) lens 300 may be a liquid crystal optical element that includes at least one layer of liquid crystals. In some examples, the Pancharatnam-Berry phase (PBP) lens 300 may include a layer of other type of substructures, e.g., nanopillars composed of high refraction index materials.

The Pancharatnam-Berry phase (PBP) lens 300 may add or remove spherical optical power based in part on polarization of incident light. For example, if right circular polarized (RCP) light is incident on Pancharatnam-Berry phase (PBP) lens 300, the Pancharatnam-Berry phase (PBP) lens 300 may act as a positive lens (i.e., it causes light to converge). If left circular polarized (LCP) light is incident on the Pancharatnam-Berry phase (PBP) lens 300, the Pancharatnam-Berry phase (PBP) lens 300 may act as a negative lens (i.e., it causes light to diverge). The Pancharatnam-Berry phase (PBP) lens 300 may also change handedness of light to the orthogonal handedness (e.g., changing left circular polarized (LCP) to right circular polarized (RCP) or vice versa).

It should be appreciated that Pancharatnam-Berry phase (PBP) lenses may also be wavelength selective. In other words, if incident light is at or within a designed wavelength, left circular polarized (LCP) light may be converted to right circular polarized (RCP) light, and vice versa. In contrast, if incident light has a wavelength that is outside the designed wavelength range, at least a portion of the light may be transmitted without change in its polarization and without focusing or converging. In some examples, Pancharatnam-Berry phase (PBP) lenses may also have a large aperture size and can be made or designed with a very thin liquid crystal layer. Optical properties of a Pancharatnam-Berry phase (PBP) lens (e.g., focusing power or diffracting power) may be based on variation of azimuthal angles θ of liquid crystal molecules. For example, for a Pancharatnam-Berry phase (PBP) lens, azimuthal angle θ of a liquid crystal molecule is determined based on Equation (1), as follows:

$$θ = ( \frac{{r}^{2}}{f} * \frac{π}{λ} ) / 2$$

where r represents a radial distance between the liquid crystal molecule and an optical center of the Pancharatnam-Berry phase (PBP) lens f represents a focal distance, and λ represents a wavelength of light for which the Pancharatnam-Berry phase (PBP) lens is designed. In some examples, azimuthal angles of the liquid crystal molecules in an x-y plane may increase from an optical center to an edge of the Pancharatnam-Berry phase (PBP) lens. In some examples, as expressed by Equation (1), a rate of increase in azimuthal angles between neighboring liquid crystal molecules may also increase with a distance from the optical center of Pancharatnam-Berry phase (PBP) lens 300. Pancharatnam-Berry phase (PBP) lens 300 may create a respective lens profile based on the orientations (i.e., azimuthal angle 8) of a liquid crystal molecule in the x-y plane of FIG. 3A. In contrast, a (non-PBP) liquid crystal lens may create a lens profile via a birefringence property (with liquid crystal molecules oriented out of x-y plane, e.g., a non-zero tilt angle from the x-y plane) and a thickness of a liquid crystal layer.

FIG. 3A illustrates a three-dimensional view of Pancharatnam-Berry phase (PBP) lens 300 with incoming light 304 entering the lens along the z-axis. FIG. 3B illustrates an x-y-plane view of Pancharatnam-Berry phase (PBP) lens 300 with a plurality of liquid crystals (e.g., liquid crystals 302A and 302B) with various orientations. The orientations (i.e., azimuthal angles θ) of the liquid crystals vary along reference line between A and A′ from the center of Pancharatnam-Berry phase (PBP) lens 300 toward the periphery of Pancharatnam-Berry phase (PBP) lens 300.

FIG. 3C illustrates an x-z-cross-sectional view of Pancharatnam-Berry phase (PBP) lens 300. As shown in FIG. 3C, the orientations of the liquid crystal (e.g., liquid crystals 302A and 302B remain constant along z-direction. FIG. 3C illustrates an example of a Pancharatnam-Berry phase (PBP) structure that has constant orientation along the z-axis and a birefringent thickness (Δn×t) that is ideally half of the designed wavelength, where Δn represents a birefringence of the liquid crystal material and t represents physical thickness of the plate.

In some examples, a Pancharatnam-Berry phase (PBP) optical element (e.g., lens, grating) may have a liquid crystal structure that is different from the one shown in FIG. 3C. For example, a Pancharatnam-Berry phase (PBP) optical element may include a double twist liquid crystal structure along the z-direction. In another example, a Pancharatnam-Berry phase (PBP) optical element may include a three-layer alternate structure along the z-direction in order to provide achromatic response across a wide spectral range.

FIG. 3D illustrates a detailed plane view of the liquid crystals along a reference line between A and A′ shown in FIG. 3B. Pitch 306 may be defined as a distance along the x-axis at which the azimuthal angle θ of a liquid crystal has rotated 180 degrees. In some examples, pitch 306 may vary as a function of distance from a center of the Pancharatnam-Berry phase (PBP) lens 300. In a case of a spherical lens, the azimuthal angle θ of liquid crystals may vary in accordance with Equation (1) described above. In such cases, the pitch at the center of the lens may be longest and the pitch at the edge of the lens may be shortest.

### Balanced Switchable Examples

As described above, the Pancharatnam-Berry phase (PBP) lens or geometric phase lens (GPL), in some examples, may be specifically designed for circularly polarized illumination, at normal and/or non-normal angles of incidence (AOI). However, if illumination is not strictly or perfectly circularly polarized (i.e., elliptically polarized), the Pancharatnam-Berry phase (PBP) lens may create an undesirable “ghost” effect and adversely affect visual acuity for a user or wearer of the head-mounted display (HMD). For a switchable accommodation to function with a Pancharatnam-Berry phase (PBP) lens, a switchable half wave retarder may be used to “flip” illumination from right circular polarized (RCP) to right circular polarized (RCP) illumination.

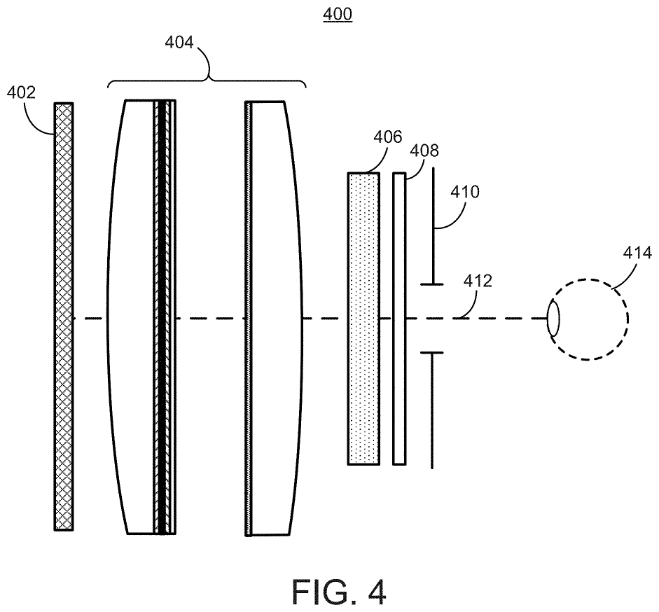

FIG. 4 illustrates an optical lens assembly 400 for a switchable accommodation using a Pancharatnam-Berry phase (PBP) lens and a switchable half wave plate, according to an example. As shown, the optical lens assembly 400 may include a display 402, an optical stack 404, a switchable optical element 406, and an optical element 408. Illumination 412 from the display 402 may traverse all these optical components in this optical lens assembly 400 to create one or more visual images at an eye 414 of a user.

The display 402 may be similar to the electronic display 155 described with respect to FIG. 1. The optical stack 404 may include any number of optical components. In some examples, the optical stack 404 may be similar to the optics block 165 described with respect to FIG. 1. In some examples, the optical stack 404 may include any number of pancake optics or pancake optical stacks, as shown.

The switchable optical element 406 may be any number of switchable optical elements. For example, the switchable optical element 406 may include a switchable optical retarder, a switchable half wave plate, or other switchable optical element, which may be communicatively coupled to a controller (not shown). The controller may apply voltage to the switchable optical element 406 to configure the switchable optical element 406 to be in at least a first optical state or a second optical state. In some examples, the first optical state may be an “off” state and the second optical state may be an “on” state. Together, the first optical state and the second optical state may allow the switchable optical element 406 to manipulate polarization states and provide a “balanced” switchable configuration as described herein.

It should be appreciated that the switchable optical element 406 may include any number of switchable optical materials. In some examples, the switchable optical element 406 may include a liquid crystal (LC) cell, such as a nematic liquid crystal (LC) cell, a nematic liquid crystal (LC) cell with chiral dopants, a chiral liquid crystal (LC) cell, a uniform lying helix (ULH) liquid crystal (LC) cell, a ferroelectric liquid crystal (LC) cell, or the like. In other examples, the liquid crystal (LC) cell may include an electrically drivable birefringence material or other similar material.

The optical element 408 may include any number of optical elements, such as a Pancharatnam-Berry phase (PBP) lens (e.g., geometric phase lens (GPL)), a polarization sensitive hologram (PSH) lens, Pancharatnam-Berry grating (PBG) (e.g., geometric phase grating), a polarization sensitive hologram (PSH) grating, a metamaterial (e.g., metasurface), a liquid crystal optical phase array, etc. Although examples described herein refer to the optical element 408 as a Pancharatnam-Berry phase (PBP) lens, any of these or other types of optical elements may also apply. The optical element 408 may also be communicatively coupled to a controller, which may apply voltage to the optical element 408.

In order to configure the Pancharatnam-Berry phase (PBP) lens so that it will not generate “ghosts” (or other undesirable visual artifacts) for illumination that is not strictly or perfectly circularly polarized, the switchable optical element 406 may be configured so that the “on” state ellipticity, as a function of angle of incidence (AOI) and azimuth, is closely matched to the “off” state ellipticity, as a function of angle of incidence (AOI) and azimuth.

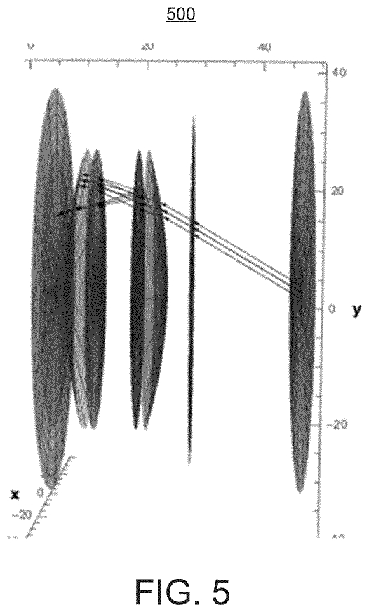

FIG. 5 illustrates a geometric ray trace 500 for an optical configuration, according to an example. As shown, the geometric ray trace 500 may illustrate a ray path of an off-axis field point for an optical configuration for a switchable accommodation using a Pancharatnam-Berry phase (PBP) lens and switchable half wave plate.

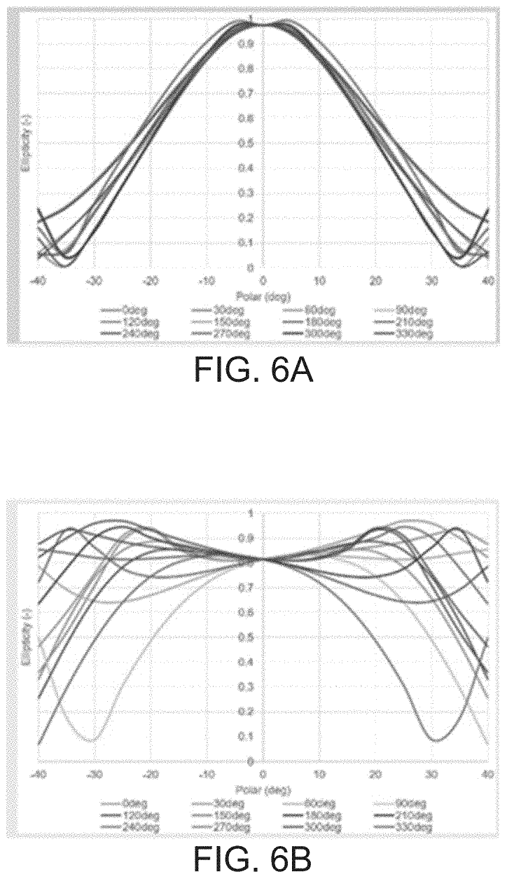

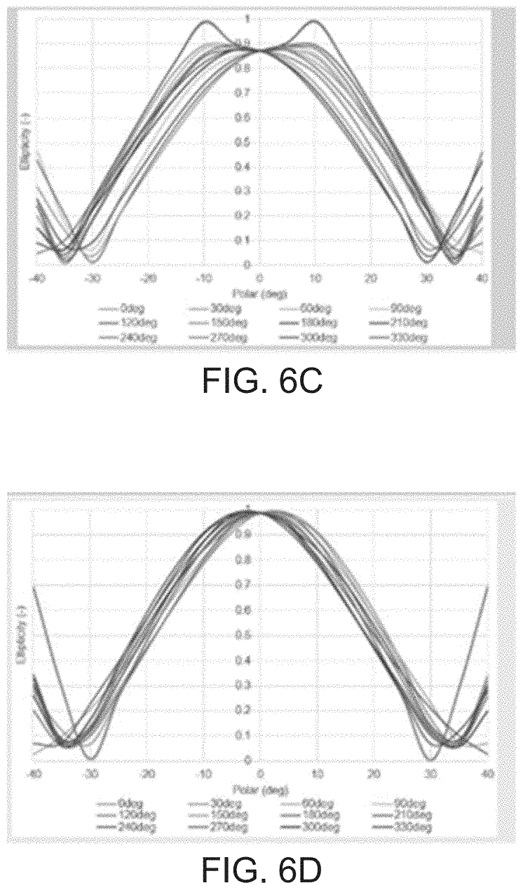

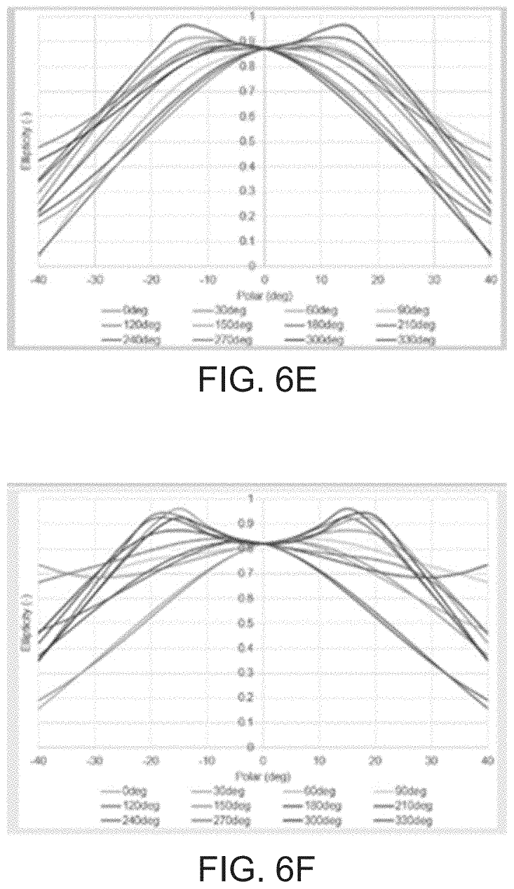

To help illustrate, reference is made to FIGS. 6A-6F, which illustrates various graphs depicting “balanced” and “imbalanced” switchable half wave plate configurations, according to an example. FIGS. 6A-6B, for example, illustrate ellipticity variation versus polar angle and angle of incidence (AOI). Specifically, FIG. 6A depicts an “off” state and FIG. 6B depicts an “on” state. When compared with each other, it should be appreciated the relatively large variation in ellipticity vs. AOI between the “off” and “on” states. In other words, these relative differences in ellipticity profiles is what creates an “imbalanced” design, which results in “ghost” effects.

FIGS. 6C-6D illustrate ellipticity variation versus polar angle and angle of incidence (AOI) without compensation, and FIGS. 6E-6F illustrate ellipticity variation versus polar angle and angle of incidence (AOI) with compensation. When comparing the “off” states—without compensation (FIG. 6C) or with compensation (FIG. 6E)—to the “on” states—without compensation (FIG. 6D) or with compensation (FIG. 6F), it should be appreciated that the variation in ellipticity vs. angle of incidence (AOI) may be substantially reduced. In other words, the ellipticity profiles may appear to be more similar in shape/contours, and thus, creates a more “balanced” design. Ultimately, use of this technique may enable design that reduces or eliminates undesirable “ghost” effects when illumination is not perfectly circular in polarization.

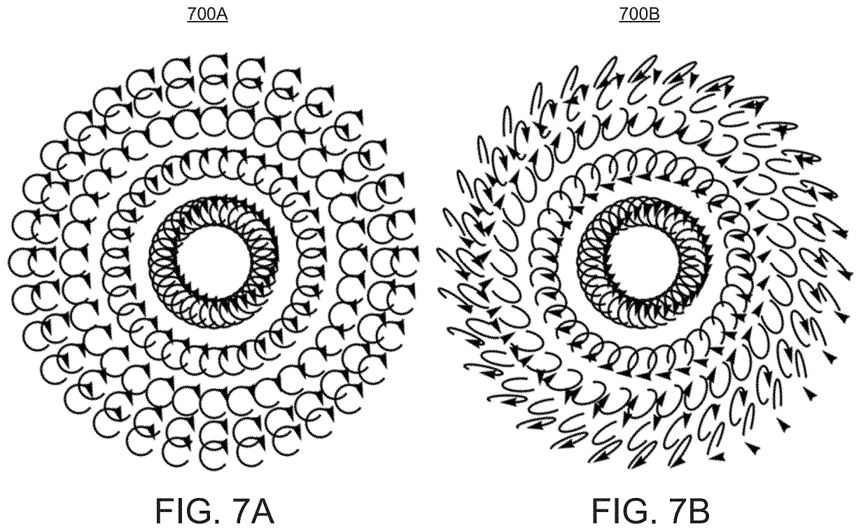

FIGS. 7A-7B illustrate PBP illumination design conditions 700A-700B, according to an example. As shown in FIG. 7A, typical PBP illumination design conditions 700A for incident polarization versus field/AOIs is generally circular polarization for all AOIs. However, techniques described herein may provide PBP illumination design conditions 700B for incident polarization versus field/AOIs for not only circular polarization at normal incidence, but also more elliptical polarization with increasing field/AOI, as shown.

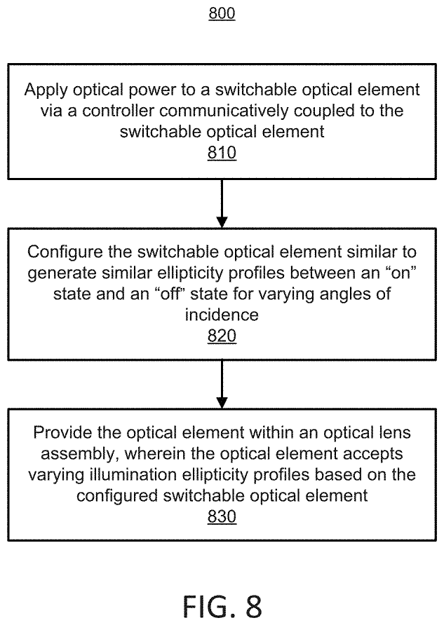

FIG. 8 illustrates a flow chart of a method for providing balanced switchable configurations for a Pancharatnam-berry phase (PBP) lens to accept various illumination ellipticity profiles as angle of incidence (AOI) varies, according to an example. The method 800 is provided by way of example, as there may be a variety of ways to carry out the method described herein. Although the method 800 is primarily described as being performed by the system 100 of FIG. 1 and/or optical lens assembly 400 of FIG. 4, the method 800 may be executed or otherwise performed by one or more processing components of another system or a combination of systems. Each block shown in FIG. 8 may further represent one or more processes, methods, or subroutines, and one or more of the blocks may include machine readable instructions stored on a non-transitory computer readable medium and executed by a processor or other type of processing circuit to perform one or more operations described herein.

At block 810, optical power may be applied to the switchable optical element 406 of FIG. 1. This may be achieved by using a controller communicatively coupled to the switchable optical element. As described above, the switchable optical element may be a switchable half wave plate or switchable half wave retarder, and may include aa liquid crystal (LC) cell, comprising at least one of a nematic liquid crystal (LC) cell, a nematic liquid crystal (LC) cell with chiral dopants, a chiral liquid crystal (LC) cell, a uniform lying helix (ULH) liquid crystal (LC) cell, a ferroelectric liquid crystal (LC) cell, or an electrically drivable birefringence material.

At block 820, the switchable optical element 406 may be configured to accept varying illumination ellipticity profiles by substantially matching or balancing an “on” state elliptically with an “off” state elliptically in angle of incidence (AOI) and as the angle of incidence (AOI) increases. As described above, the optical element may include a Pancharatnam-Berry phase (PBP) lens, a geometric phase lens (GPL), a polarization sensitive hologram (PSH) lens, a polarization sensitive hologram (PSH) grating, a metamaterial or metasurface, or a liquid crystal optical phase array, a combination thereof or other optical element.

At block 830, the optical element may be provided within an optical lens assembly. Here, the optical element may accept varying illumination ellipticity profiles based on the configured switchable optical element.

For an optical assembly that uses a Pancharatnam-Berry phase (PBP) lens, for example, it should be appreciated that the Pancharatnam-Berry phase (PBP) lens may be designed to compensate for non-ideal illumination that is circular at normal incidence but increasingly elliptical off-axis using a c-plate or layers of biaxial liquid crystal materials.

Accordingly, a switchable half wave plate (SHWP) may be “balanced” in order to generate similar ellipticity profiles between the “on” state and “off” state for varying angles of incidence as described herein. Specifically, this may be achieved by using at least a combination of compensation films or layers to compensate for any or all ellipticity degradation in the liquid crystal (LC) cell “on” state without overly degrading the liquid crystal (LC) cell “off” state. In other words, when the switchable half wave plate (SHWP) ellipticity output for the “on” state and the “off” state are made to be similar as the angle of incidence (AOI) varies, then the Pancharatnam-Berry phase (PBP) may be appropriately co-designed for that elliptical polarization state generated by the switchable half wave plate (SHWP). It should be appreciated, for example, that this may be achieved with any number of or varieties of C plates and/or biaxial liquid crystal layers (or other type of compensation layers or similar elements) in a given Pancharatnam-Berry phase (PBP). Here, the C plate or biaxial/discotic layers in the Pancharatnam-Berry phase (PBP) may compensate for the elliptical profile generated by the switchable half wave plate (SHWP).

The systems and methods described herein may provide a “balanced” switchable half wave plate configuration, which, for example, may be used in a head-mounted display (HMD) or other optical applications. It should be appreciated that the design of the switchable half wave plate may include liquid crystal cell design, which may be optimized so that the “on” state elliptically is closely matched to the “off” state elliptically in angle of incidence AOI). In this way, the Pancharatnam-Berry phase (PBP) lens may be designed or optimized to accept varying illumination ellipticity profile, and in situations where angle of incidence (AOI) increases. In this way, distortion or other adverse optical effects, such as “ghosts” may be reduced or eliminated for users or wears of the head-mounted display (HMD) having a Pancharatnam-Berry phase (PBP) lens.

### ADDITIONAL INFORMATION

The benefits and advantages of the optical lens confirmations described herein, may include, among other things, reduction or elimination of “ghost” effects and improved visual acuity in headsets used in virtual reality (VR), augmented reality (AR), and/or mixed reality (MR) environments, or other similar optical devices

As mentioned above, there may be numerous ways to configure, provide, manufacture, or position the various optical, electrical, and/or mechanical components or elements of the examples described above. While examples described herein are directed to certain configurations as shown, it should be appreciated that any of the components described or mentioned herein may be altered, changed, replaced, or modified, in size, shape, and numbers, or material, depending on application or use case, and adjusted for desired resolution or optimal results. In this way, other electrical, thermal, mechanical and/or design advantages may also be obtained.

It should be appreciated that the apparatuses, systems, and methods described herein may facilitate more desirable headsets or visual results. It should also be appreciated that the apparatuses, systems, and methods, as described herein, may also include or communicate with other components not shown. For example, these may include external processors, counters, analyzers, computing devices, and other measuring devices or systems. In some examples, this may also include middleware (not shown) as well. Middleware may include software hosted by one or more servers or devices. Furthermore, it should be appreciated that some of the middleware or servers may or may not be needed to achieve functionality. Other types of servers, middleware, systems, platforms, and applications not shown may also be provided at the back-end to facilitate the features and functionalities of the headset.

Moreover, single components described herein may be provided as multiple components, and vice versa, to perform the functions and features described above. It should be appreciated that the components of the apparatus or system described herein may operate in partial or full capacity, or it may be removed entirely. It should also be appreciated that analytics and processing techniques described herein with respect to the waveguide configurations, for example, may also be performed partially or in full by these or other various components of the overall system or apparatus.

It should be appreciated that data stores may also be provided to the apparatuses, systems, and methods described herein, and may include volatile and/or nonvolatile data storage that may store data and software or firmware including machine-readable instructions. The software or firmware may include subroutines or applications that perform the functions of the measurement system and/or run one or more application that utilize data from the measurement or other communicatively coupled system.

The various components, circuits, elements, components, and/or interfaces, may be any number of optical, mechanical, electrical, hardware, network, or software components, circuits, elements, and interfaces that serves to facilitate communication, exchange, and analysis data between any number of or combination of equipment, protocol layers, or applications. For example, some of the components described herein may each include a network or communication interface to communicate with other servers, devices, components or network elements via a network or other communication protocol.

Although examples are directed to head-mounted displays (HMDs), it should be appreciated that the apparatuses, systems, and methods described herein may also be used in other various systems and other implementations. For example, these may include other various head-mounted systems, eyewear, wearable devices, optical systems, etc. in any number of virtual reality (VR), augmented reality (AR), and/or mixed reality (MR) environments. In fact, there may be numerous applications in various optical or data communication scenarios.

It should be appreciated that the apparatuses, systems, and methods described herein may also be used to help provide, directly or indirectly, measurements for distance, angle, rotation, speed, position, wavelength, transmissivity, and/or other related optical measurements. For example, the systems and methods described herein may allow for a higher resolution optical resolution using an efficient and cost-effective design concept. With additional advantages that include higher resolution, lower number of optical elements, more efficient processing techniques, cost-effective configurations, and smaller or more compact form factor, the apparatuses, systems, and methods described herein may be beneficial in many original equipment manufacturer (OEM) applications, where they may be readily integrated into various and existing equipment, systems, instruments, or other systems and methods. The apparatuses, systems, and methods described herein may provide mechanical simplicity and adaptability to small or large headsets. Ultimately, the apparatuses, systems, and methods described herein may increase resolution, minimize adverse effects of traditional systems, and improve visual efficiencies.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. An optical lens assembly, comprising:
an optical stack;
a switchable optical element communicatively coupled to a controller; and
an optical element;
wherein the switchable optical element is configured, via application of optical power by the controller, to accept varying illumination ellipticity profiles.

2. The optical lens assembly of claim 1, wherein the optical stack comprises pancake optics.

3. The optical lens assembly of claim 1, wherein the switchable optical element comprises a switchable half wave plate or switchable half wave retarder.

4. The optical lens assembly of claim 1, wherein the switchable optical element comprises a liquid crystal (LC) cell comprising at least one of a nematic liquid crystal (LC) cell, a nematic liquid crystal (LC) cell with chiral dopants, a chiral liquid crystal (LC) cell, a uniform lying helix (ULH) liquid crystal (LC) cell, a ferroelectric liquid crystal (LC) cell, or an electrically drivable birefringence material.

5. The optical lens assembly of claim 1, wherein the optical element comprises at least one of a Pancharatnam-Berry phase (PBP) lens, a geometric phase lens (GPL), a Pancharatnam-Berry grating (PBG), a geometric phase grating (GPG), a polarization sensitive hologram (PSH) lens, a polarization sensitive hologram (PSH) grating, a metamaterial or metasurface, or a liquid crystal optical phase array.

6. The optical lens assembly of claim 1, wherein the optical element is configured to accept varying illumination ellipticity profiles as angle of incidence (AOI) increases.

7. The optical lens assembly of claim 1, wherein the switchable optical element is configured to generate varying illumination ellipticity profiles by substantially matching or balancing an “on” state ellipticity with an “off” state ellipticity with increasing angle of incidence (AOI).

8. The optical lens assembly of claim 1, wherein the optical lens assembly is part of a head-mounted display (HMD) used in at least one of a virtual reality (VR), augmented reality (AR), or mixed reality (MR) environment.

9. A head-mounted display (HMD), comprising:
a display element to provide display light;
an optical assembly to provide display light to a user of the head-mounted display (HMD), the optical assembly comprising:
an optical stack;
a switchable optical element communicatively coupled to a controller; and
an optical element;
wherein the optical element is configured, via one or more compensation layers, to accept varying illumination ellipticity profiles.

10. The head-mounted display (HMD) of claim 9, wherein the switchable optical element comprises a switchable half wave plate or switchable half wave retarder.

11. The head-mounted display (HMD) of claim 9, wherein the switchable optical element comprises a liquid crystal (LC) cell comprising at least one of a nematic liquid crystal (LC) cell, a nematic liquid crystal (LC) cell with chiral dopants, a chiral liquid crystal (LC) cell, a uniform lying helix (ULH) liquid crystal (LC) cell, a ferroelectric liquid crystal (LC) cell, or an electrically drivable birefringence material.

12. The head-mounted display (HMD) of claim 9, wherein the optical element comprises at least one of a Pancharatnam-Berry phase (PBP) lens, a geometric phase lens (GPL), a Pancharatnam-Berry grating (PBG), a geometric phase grating (GPG), a polarization sensitive hologram (PSH) lens, a polarization sensitive hologram (PSH) grating, a metamaterial or metasurface, or a liquid crystal optical phase array.

13. The head-mounted display (HMD) of claim 9, wherein the optical element is configured to accept varying illumination ellipticity profiles as angle of incidence (AOI) increases.

14. The head-mounted display (HMD) of claim 9, wherein the switchable optical element is configured to generate varying illumination ellipticity profiles by substantially matching or balancing an “on” state elliptically with an “off” state elliptically in angle of incidence (AOI).

15. The head-mounted display (HMD) of claim 9, wherein the head-mounted display (HMD) is used in at least one of a virtual reality (VR), augmented reality (AR), or mixed reality (MR) environment.

16. A method for providing an optical component of an optical lens assembly, comprising:
applying optical power to a switchable optical element via a controller communicatively coupled to the switchable optical element; and
configuring the switchable optical element to generate similar ellipticity profiles between an “on” state and an “off” state for varying angles of incidence; and
providing the optical element in the optical lens assembly, wherein the optical element accepts varying illumination ellipticity profiles based on the configured switchable optical element.

17. The method of claim 16, wherein the switchable optical element comprises a switchable half wave plate or switchable half wave retarder.

18. The method of claim 16, wherein the switchable optical element comprises a liquid crystal (LC) cell comprising at least one of a nematic liquid crystal (LC) cell, a nematic liquid crystal (LC) cell with chiral dopants, a chiral liquid crystal (LC) cell, a uniform lying helix (ULH) liquid crystal (LC) cell, a ferroelectric liquid crystal (LC) cell, or an electrically drivable birefringence material.

19. The method of claim 16, wherein the optical element comprises at least one of a Pancharatnam-Berry phase (PBP) lens, a geometric phase lens (GPL), a Pancharatnam-Berry grating (PBG), a geometric phase grating (GPG), a polarization sensitive hologram (PSH) lens, a polarization sensitive hologram (PSH) grating, a metamaterial or metasurface, or a liquid crystal optical phase array.

20. The method of claim 16, wherein the switchable optical element is configured to generate a matching “on” state and “off” state ellipticity as the angle of incidence (AOI) increases and the ellipticity performance degrades, so that the optical element accepts and compensates for the varying illumination ellipticity, using at least one of a C plate or biaxial liquid crystal layer of the optical element.
